(19) United States
(12) Patent Application Publication
(10) Pub. No.: US 2022/0239406 A1
(43) Pub. Date: Jul. 28, 2022

(54) GATEWAY DEVICE, DATA FRAME TRANSMISSION METHOD, AND PROGRAM

(71) Applicant: Hitachi Astemo, Ltd., Hitachinaka-shi, Ibaraki (JP)

(72) Inventors: Masaaki NAKAMURA, Hitachinaka-shi (JP); Kazuhiro NAKANISHI, Hitachinaka-shi (JP)

(73) Assignee: Hitachi Astemo, Ltd., Hitachinaka-shi, Ibaraki (JP)

(21) Appl. No.: 17/626,393

(22) PCT Filed: Jul. 10, 2020
(86) PCT No.: PCT/JP2020/026966

§ 371 Date: Jan. 11, 2022

(30) Foreign Application Priority Data
Jul. 19, 2019 (JP) 2019-133678

(51) Int. Cl. H04L 1/00

(52) U.S. Cl. CPC H04L 1/0027

(57) ABSTRACT

An increase in a processing load can be suppressed by adjusting a frame retransmission timing according to a communication status and a load state. A gateway device that relays a data frame between ECUs connected to an in-vehicle network, includes: a monitoring processing unit that monitors a predetermined monitored target; and a transmission control unit that transmits the data frame to the ECU. The monitoring processing unit is configured to: calculate a transmission interval time of the data frame according to a communication status in the in-vehicle network or a load state of internal processing of the gateway device. The transmission control unit is configured to: transmit the data frame to the ECU based on the calculated transmission interval time.

### TECHNICAL FIELD

The present invention relates to a gateway device, a data frame transmission method, and a program.

### BACKGROUND ART

PTL 1 relates to a communication device, and describes that “the first ECU acquires external information from an external device, and performs information communication based on a communication message defined in a CAN protocol via a communication bus. The first ECU includes: a communication necessity determining unit that determines necessity of information communication via a communication bus on the basis of acquired external information; and a communication control unit that, when the determined necessity of the information communication is “necessary”, stops the information communication for a certain period on condition that a communication error is detected, and restarts the information communication after the certain period has elapsed, and when the determined necessity of the information communication is “unnecessary”, stops transmission of a communication message until a predetermined transmission restart condition is satisfied”.

### CITATION LIST

### Patent Literature

PTL 1: JP 5958975 B1

### SUMMARY OF INVENTION

### Technical Problem

The communication device described in PTL 1 stops transmission of a communication message and suppresses power consumption of an electronic control unit (ECU) as a transmission source when determining that a communication error is caused under a specific condition in a case where there is no response from the ECU as a transmission destination of the communication message. However, when the transmission of the communication message is temporarily stopped, the transmission of the communication message is stopped until the recovery of the failed ECU is detected. Therefore, there is a problem that a delay due to a time lag occurs until the transmission of the communication message is resumed after the recovery.

In addition, in a case where the condition is not the specific condition, the communication device of the literature continues to retransmit the communication message until the transmission destination ECU recovers, but since the retransmission is periodically repeated at predetermined time intervals, there is a problem that the processing load of the communication device increases.

The present invention has been made in view of the above problems, and an object of the present invention is to provide a gateway device capable of suppressing an increase in processing load by adjusting a frame retransmission timing according to a communication status and a load state.

### Solution to Problem

The present application includes a plurality of means for solving at least a part of the above problems, and examples thereof are as follows. A gateway device according to one aspect of the present invention that solves the above problem is a gateway device that relays a data frame between ECUs connected to an in-vehicle network. The gateway device includes: a monitoring processing unit that monitors a predetermined monitored target; and a transmission control unit that transmits the data frame to the ECU. The monitoring processing unit is configured to calculate a transmission interval time of the data frame according to a communication status in the in-vehicle network or a load state of internal processing of the gateway device. The transmission control unit is configured to: transmit the data frame to the ECU based on the calculated transmission interval time.

### Advantageous Effects of Invention

According to the gateway device of the present invention, the increase in the processing load can be suppressed by adjusting the frame retransmission timing according to the communication status and the load state. Other features of the invention will be clear from the description and the accompanying drawings. In addition, objects, configurations, and effects besides the above description will be apparent through the explanation on the following embodiments.

### BRIEF DESCRIPTION OF DRAWINGS

FIG. 1 is a diagram illustrating an example of a schematic configuration of an in-vehicle network system.

FIG. 2 is a diagram illustrating an example of a hardware configuration of a gateway device.

FIG. 3 is a diagram illustrating an example of a flowchart illustrating a flow of transmission interval adjustment processing.

### DESCRIPTION OF EMBODIMENTS

Hereinafter, embodiments of the invention will be described using the drawings.

### First Embodiment

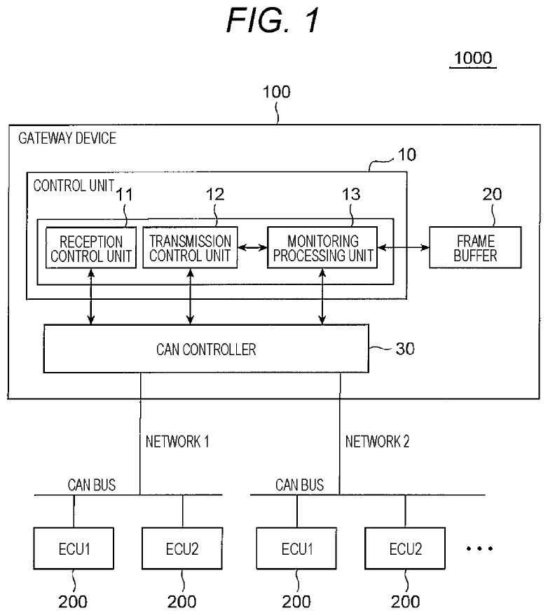

FIG. 1 is a diagram illustrating an example of a schematic configuration of an in-vehicle network system 1000 according to the present embodiment. The in-vehicle network system 1000 is a network system mounted on a vehicle, and is configured by, for example, a controller area network (CAN).

As illustrated, the in-vehicle network system 1000 includes a gateway device 100 and an ECU 200 belonging to individual network connected to the gateway device 100. The ECUs 200 each transmit and receive a CAN frame (such as data frame and error frame) relayed by the gateway device 100 via a CAN bus, thereby performing information communication with each other. The ECU 200 is a control device used for various controls of the vehicle, and a plurality of ECUs 200 are connected to the gateway device 100 via the CAN bus according to a control target. Examples of the ECU 200 include an engine ECU and a charge control ECU that control a drive system, a steering ECU and a brake ECU that control a traveling system, and a door ECU and a seat ECU that control a vehicle body system.

The gateway device 100 includes, for example, a computer, and is a device that relays CAN frames exchanged between various networks included in in-vehicle network system 1000. Specifically, the gateway device 100 performs relay processing of transmitting a CAN frame acquired from ECU 200 belonging to a certain network to the ECU 200 as a transmission destination.

Note that, in a case where the transmission destination ECU 200 fails in function, the gateway device 100 holds the CAN frame that has not been received as a pending frame, and repeats retransmission processing until the CAN frame is received. However, when the processing load of the gateway device 100 increases by repeating the retransmission processing, the frame transmission processing to different ECUs 200 is also affected, and as a result, communication to each network connected to the gateway device 100 is also affected. Therefore, the gateway device 100 monitors whether a predetermined setting condition related to the communication status or the state of the processing load is satisfied, and performs transmission interval adjustment processing of adjusting the transmission timing (transmission time interval) of the pending frame according to the monitoring result.

As illustrated in the drawing, the gateway device 100 includes a control unit 10, a frame buffer 20, and a CAN controller 30. Further, the control unit 10 is a functional unit that controls various relay processing of the gateway device 100, and includes a reception control unit 11, a transmission control unit 12, and a monitoring processing unit 13.

The reception control unit 11 is a functional unit that performs reception control of the CAN frame transmitted from the ECU 200 via the CAN controller 30.

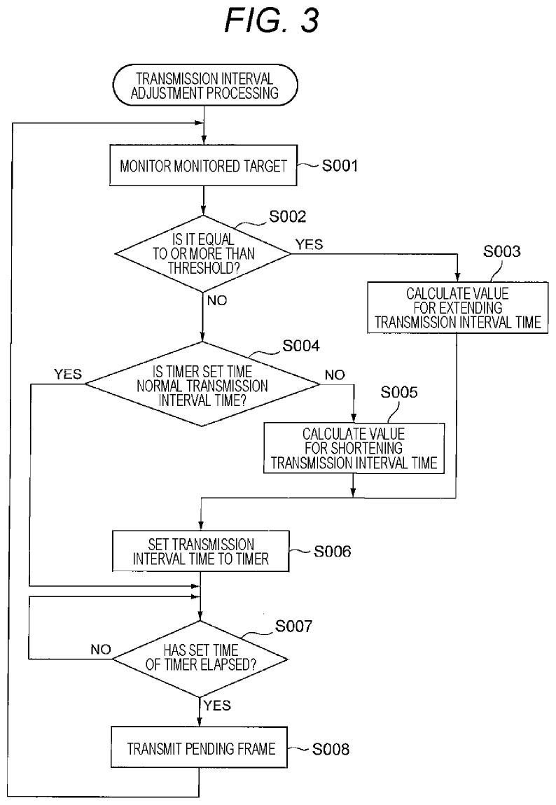

The transmission control unit 12 is a functional unit that performs transmission control of a CAN frame to be transmitted to the ECU 200. Specifically, the transmission control unit 12 transmits the CAN frame to target ECU 200 based on a transmission interval time set in a timer. Further, in a case where a predetermined setting condition is satisfied, the transmission control unit 12 adjusts the transmission interval of the CAN frame. Note that the transmission interval adjustment processing will be described in detail with reference to the flowchart illustrated in FIG. 3.

The monitoring processing unit 13 is a functional unit that monitors whether a predetermined setting condition related to the communication status or the state of the processing load is satisfied. Specifically, the monitoring processing unit 13 determines whether the quantity of pending frames (the number of pending frames) is equal to or larger than a set threshold (or less than the set threshold). In addition, the monitoring processing unit 13 calculates an interval time (retransmission interval) for changing the transmission interval of the CAN frame to be retransmitted according to the determination result.

The frame buffer 20 is a functional unit for temporarily storing a pending frame. Specifically, frame buffer 20 temporarily stores, as a pending frame, a CAN frame that has not been received by a failed ECU 200.

The CAN controller 30 acquires the CAN frame via the CAN bus connected to the gateway device 100. In addition, the CAN controller 30 transmits the CAN frame related to the relay to the CAN bus. The CAN controller 30 also monitors a communication status of the CAN bus (for example, traffic conditions, load factors, and the like). When the acquired CAN frame is an error frame (error flag), the CAN controller 30 detects a network communication error and counts the number of detected errors. In addition, the CAN controller 30 periodically receives a connection confirmation signal from each ECU 200 via the CAN bus.

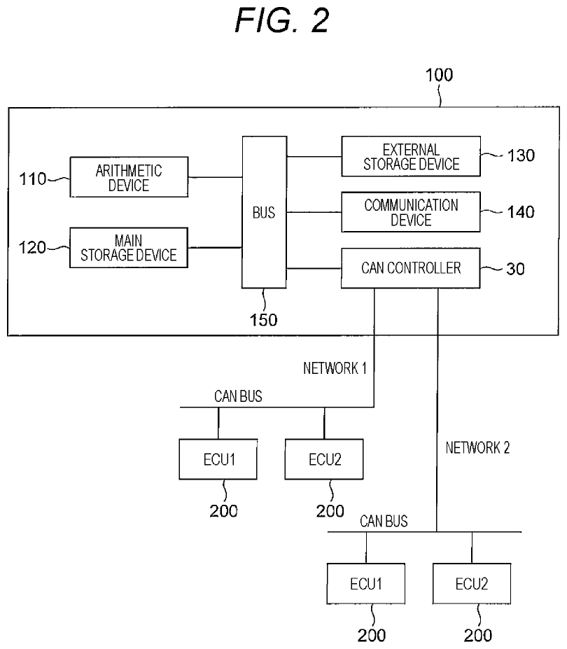

FIG. 2 is a diagram illustrating an example of a hardware configuration of the gateway device 100. The gateway device 100 is realized by a high-performance information processing device including an arithmetic device 110, a main storage device 120, an external storage device 130, a communication device 140, and the CAN controller 30.

The arithmetic device 110 is configured by, for example, a central processing unit (CPU). The main storage device 120 is configured by a memory device such as a random access memory (RAM) or a read only memory (ROM).

The external storage device 130 is, for example, a non-volatile storage device such as a hard disk drive, a solid state drive (SSD), or a flash memory.

The communication device 140 is, for example, a wireless communication device that performs wireless communication via an antenna. The communication device 140 performs information communication with an external device.

The CAN controller 30 is a physical interface that implements a function of the CAN protocol and transmits and receives CAN frames to and from the CAN bus. The CAN controller 30 includes, for example, a microcontroller (microcomputer), a CAN protocol controller, and a CAN transceiver, and there are various types such as a stand-alone type and a microcomputer built-in type.

The hardware configuration of the gateway device 100 has been described above.

Note that the control unit 10 of the gateway device 100 is realized by a program that causes the arithmetic device 110 to perform processing. This program is stored in the main storage device 120 or the external storage device 130, loaded on the main storage device 120 when the program is executed, and executed by the arithmetic device 110. In addition, the frame buffer 20 may be realized by a built-in memory of the CAN controller 30 or the main storage device 120, or may be realized by a combination thereof.

Next, the transmission interval adjustment processing performed by the gateway device 100 will be described.

FIG. 3 is a diagram illustrating an example of a flowchart illustrating a flow of the transmission interval adjustment processing. Note that the transmission interval adjustment processing is started when the gateway device 100 is activated. Note that, in the following, an example of a case where the ECU 200 belonging to a certain network fails and the number of pending frames becomes equal to or larger than a threshold and an example of a case where the number of pending frames becomes less than the threshold due to reception of the pending frame by the ECU 200 that has recovered from the failure will be described in order.

When the processing is started, the monitoring processing unit 13 monitors a monitored target (Step S001). Specifically, the monitoring processing unit 13 monitors the number of pending frames temporarily stored in the frame buffer 20. Note that the number of pending frames may be the number of pending frames stored in the frame buffer 20 or the number for each ID (so-called CAN ID) included in the standard format of the CAN frame.

Next, the monitoring processing unit 13 determines whether the number of pending frames is equal to or larger than a preset threshold (Step S002). In this example, since it is assumed that the number of pending frames is equal to or larger than the threshold due to a failure of the transmission destination ECU 200 of the CAN frame, the monitoring processing unit 13 determines that the number of pending frames is equal to or larger than the threshold (Yes in Step S002), and calculates a value for extending the transmission interval time (Step S003). Specifically, the monitoring processing unit 13 calculates a time to be added to the currently set transmission interval time for retransmission of the pending frame, and shifts the process to Step S006.

In Step S006, the monitoring processing unit 13 sets, in the timer, the transmission interval time obtained by adding the time calculated in Step S003 to the currently set transmission interval time for retransmission of the pending frame.

Further, the transmission control unit 12 determines whether the set time of the timer has elapsed (Step S007). Then, when it is determined that the set time has not elapsed (No in Step S007), the transmission control unit 12 performs the processing of Step S007 again. On the other hand, when it is determined that the set time has elapsed (Yes in Step S007), the transmission control unit 12 transmits the pending frame to the target ECU 200 (Step S008; transmission step), the process returns to Step S001.

When such processing of Steps S001 to S008 is repeatedly performed, the transmission interval time of the pending frame set in the timer is gradually extended (the transmission interval is lengthened) in a case where the number of pending frames is accumulated to be equal to or larger than the set threshold. Therefore, the processing load of the gateway device 100, which is increased by periodically retransmitting the pending frame to the failed ECU 200, is reduced.

In addition, since the gateway device 100 continuously transmits the pending frame while adjusting the transmission interval time, when the ECU 200 recovers from the failure, the pending frame can be delivered to the target ECU 200 without causing a large time lag.

As described above, by monitoring the number of pending frames, the gateway device 100 according to the present embodiment adjusts a retransmission timing of the CAN frame according to the communication status in which the CAN frame cannot be transmitted due to the failure of the ECU 200. As a result, the gateway device 100 can suppress an increase in the processing load.

In addition, in the process of Step S002 executed in a state where the ECU 200 has recovered from the failure and the number of pending frames has become less than the threshold, the monitoring processing unit 13 determines that the number of pending frames is not equal to or larger than the threshold (No in Step S002), and proceeds the process to Step S004.

In Step S004, the monitoring processing unit 13 determines whether the set time of the timer is a normal transmission interval time. Specifically, the monitoring processing unit 13 determines whether the transmission interval time set in the timer is a normal transmission interval time, that is, a transmission interval time to which a time for extending the transmission interval is not added. Then, when it is determined as the normal transmission interval time (Yes in Step S004), the monitoring processing unit 13 shifts the process to Step S007 and performs the same processing as described above.

On the other hand, when the time for extending the transmission interval is added to the timer set time and it is determined that it is not the normal transmission interval time (No in Step S004), the monitoring processing unit 13 calculates a value for shortening the transmission interval time (Step S005). Specifically, the monitoring processing unit 13 calculates a time for decreasing the transmission interval time of the pending frame set when the number of pending frames becomes equal to or larger than the threshold, and shifts the process to Step S006.

Next, in Step S006, the monitoring processing unit 13 sets, in the timer, a transmission interval time obtained by subtracting the time calculated in Step S005 from the currently set transmission interval time for retransmission of the pending frame, that is, the extended transmission interval time. Then, as described above, after the processing of Step S007 and Step S008 is performed, the process returns to Step S001 again.

When such processing of Steps S001 to S008 is repeatedly performed, in a case where the number of pending frames is less than the set threshold, the transmission interval time of the pending frame set in the timer is gradually shortened. Therefore, when the ECU 200 recovers from the failure and enters a state in which the pending frame is received, the gateway device 100 can advance the transmission interval time of the pending frame to the target ECU 200 and return the transmission interval time to the normal retransmission time.

Note that the transmission interval time set in the timer may be applied only to the transmission timing of the pending frame to the failed ECU 200, or may be applied to the transmission timing to all the ECUs 200 connected to the gateway device 100.

### Second Embodiment

In the first embodiment, the transmission interval time for retransmitting the pending frame is adjusted with the number of pending frames as a monitored target. However, in the present embodiment, the transmission interval time is adjusted with the processing load of the gateway device 100 as a monitored target.

Specifically, in Step S001 of the transmission interval adjustment processing, the monitoring processing unit 13 monitors the state of the processing load due to retransmission of the pending frame (monitoring step). More specifically, the monitoring processing unit 13 acquires, from the transmission control unit 12, information indicating the magnitude of the processing load due to retransmission of the pending frame.

Then, the monitoring processing unit 13 adjusts the transmission interval time for retransmission of the pending frame by repeatedly performing the processing in and after Step S002 described above on the basis of a comparison between the magnitude of the processing load and a threshold of the preset processing load.

Similarly to the first embodiment, the transmission interval time set in the timer may be applied only to the transmission timing of the pending frame to the failed ECU 200, or may be applied to the transmission timing to all the ECUs 200 connected to the gateway device 100.

According to such a gateway device 100, the retransmission timing of the frame can be adjusted according to the load state increased by the retransmission of the pending frame. Therefore, the gateway device 100 can continue retransmission of the pending frame while suppressing an increase in processing load by periodically retransmitting the pending frame to the failed ECU 200.

### Third Embodiment

In the second embodiment, the transmission interval time for retransmitting the pending frame is adjusted with the processing load of the gateway device 100 as a monitored target, but the gateway device 100 according to the present embodiment adjusts the transmission interval time with the number of detected communication errors as a monitored target.

Specifically, in Step S001 of the transmission interval adjustment processing, the monitoring processing unit 13 monitors the number of detected communication errors counted by the CAN controller 30 as a monitored target. In addition, the monitoring processing unit 13 determines whether the number of detected errors is equal to or larger than a set threshold (Step S002).

When determining that the number of detected communication errors is equal to or larger than the threshold (Yes in Step S002), the monitoring processing unit 13 calculates a value for extending the transmission interval time of the pending frame (Step S003), and adds the calculated time to the current transmission interval time set in the timer (Step S006). Further, the transmission control unit 12 transmits the pending frame to the target ECU 200 according to whether the set time of the timer has elapsed (Steps S007 and S008).

If it is determined in Step S002 that the number of detected communication errors is not equal to or larger than the threshold (No in Step S002), the monitoring processing unit 13 determines whether the transmission interval time set in the timer is a normal transmission interval time (Step S004). Then, when it is determined that the time for extending the transmission interval is added to the timer set time and is not a normal transmission interval time (No in Step S004), the monitoring processing unit 13 calculates a value for shortening the transmission interval time (Step S005), and sets a transmission interval time obtained by subtracting the calculated time from the currently set transmission interval time for retransmission of the pending frame in the timer (Step S006).

Further, the transmission control unit 12 transmits the pending frame to the target ECU 200 according to whether the set time of the timer has elapsed (Steps S007 and S008).

Whether to apply the transmission interval time to only the transmission timing of the pending frame to the target to which the transmission interval time set in the timer is applied, that is, the failed ECU 200, or whether to apply the transmission interval time to the transmission timing to all the ECUs 200 connected to the gateway device 100 may be determined according to the type of the communication error. For example, when the communication error of which the number of times of detection is equal to or larger than the set threshold is an error frame (error flag) transmitted from the failed ECU 200, the gateway device 100 may apply the transmission interval time of the pending frame only to the failed ECU 200. Further, for example, in a case where the communication error of which the number of times of detection is equal to or larger than the set threshold is caused by short circuit (disconnection) of the CAN bus, the gateway device 100 may apply the transmission interval time of the pending frame to all the ECUs 200 connected thereto.

According to such a gateway device 100, it is possible to suppress an increase in the processing load by adjusting the retransmission timing of the frame according to the communication status. In particular, in a status where a communication error occurs, the ECU 200 serving as a transmission target cannot receive a CAN frame in any case of a failure of the ECU 200 or a short circuit of the CAN bus. Therefore, by adjusting the transmission interval of the pending frame to the ECU 200 on the basis of the number of detected communication errors, the gateway device 100 can continuously transmit the pending frame while suppressing an increase in its own processing load.

### Fourth Embodiment

In the third embodiment, the transmission interval time for retransmitting the pending frame is adjusted with the number of detected communication errors as a monitored target, but the gateway device 100 according to the present embodiment adjusts the transmission interval time with the duration of the communication error as a monitored target.

Specifically, in Step S001 of the transmission interval adjustment processing, the monitoring processing unit 13 monitors the duration of the communication error counted by the CAN controller 30 as a monitored target. More specifically, the monitoring processing unit 13 calculates the duration from the occurrence of the communication error for each of a type of the communication error detected by the CAN controller 30 and the transmission destination ECU 200 of the pending frame. For example, when the type of the communication error is a short circuit of the CAN bus, the monitoring processing unit 13 sets a duration from an acquisition time of a frame indicating such a type of communication error to the present as a monitored target. In addition, for example, in a case where the type of the communication error is an error frame transmitted from the failed ECU 200, the monitoring processing unit 13 sets the duration from the acquisition time of the error frame transmitted from the ECU 200 to the present as a monitored target.

In addition, the monitoring processing unit 13 determines whether the duration is equal to or longer than the set threshold (Step S002). When determining that the duration of the communication error is equal to or longer than the threshold (Yes in Step S002), the monitoring processing unit 13 calculates a value for extending the transmission interval time of the pending frame in the same manner as described above (Step S003), and adds the calculated time to the current transmission interval time set in the timer (Step S006). Further, the transmission control unit 12 transmits the pending frame to the target ECU 200 according to whether the set time of the timer has elapsed (Steps S007 and S008).

On the other hand, when it is determined in Step S002 that the duration of the communication error is not equal to or longer than the threshold (No in Step S002), the monitoring processing unit 13 determines whether the transmission interval time set in the timer is a normal transmission interval time (Step S004), and performs the following processing of Steps S005 and S006. Similarly, the transmission control unit 12 performs the processing of Steps S007 and S008.

Whether to apply the transmission interval time to only the transmission timing of the pending frame to the target to which the transmission interval time set in the timer is applied, that is, the failed ECU 200, or whether to apply the transmission interval time to the transmission timing to all the ECUs 200 connected to the gateway device 100 may be determined according to the type of the communication error as in the third embodiment.

According to such a gateway device 100, it is possible to suppress an increase in the processing load by adjusting the retransmission timing of the frame according to the communication status. In particular, in a status where a communication error occurs, the ECU 200 serving as a transmission target cannot receive a CAN frame in any case of a failure of the ECU 200 or a short circuit of the CAN bus. Therefore, by adjusting the transmission interval of the pending frame to the ECU 200 on the basis of the duration of the communication error, the gateway device 100 can continuously transmit the pending frame while suppressing an increase in its own processing load.

### Fifth Embodiment

In the fourth embodiment, the transmission interval time for retransmitting the pending frame is adjusted with the duration of the communication error as a monitored target. However, the gateway device 100 according to the present embodiment adjusts the transmission interval time with the reception status of the connection confirmation signal periodically transmitted by the ECU 200 as a monitored target.

The ECU 200 connected to the CAN bus periodically transmits a connection confirmation signal to a monitoring ECU (not illustrated) for monitoring the state of each ECU 200. On the other hand, the failed ECU 200 cannot transmit the connection confirmation signal. Therefore, the monitoring processing unit 13 according to the present embodiment monitors the reception status of the connection confirmation signal via the CAN controller 30 to estimate whether the ECU 200 has failed, and adjusts the transmission interval time for retransmission of the pending frame.

Specifically, in Step S001 of the transmission interval adjustment processing, the monitoring processing unit 13 monitors the reception status of the connection confirmation signal as a monitored target. More specifically, the monitoring processing unit 13 monitors whether the connection confirmation signal is periodically transmitted from all ECUs 200 belonging to each network included in the gateway device 100 via the CAN controller 30. In addition, in a case where there is the ECU 200 from which the reception of the connection confirmation signal is interrupted, the monitoring processing unit 13 counts an interruption duration from the previous reception.

In addition, the monitoring processing unit 13 determines whether the interruption duration is equal to or longer than a set threshold (Step S002). Then, when it is determined that the interruption duration is equal to or longer than the threshold (Yes in Step S002), the monitoring processing unit 13 calculates a value for extending the transmission interval time of the pending frame in the same manner as described above (Step S003), and adds the calculated time to the current transmission interval time set in the timer (Step S006). Further, the transmission control unit 12 transmits the pending frame to the target ECU 200 according to whether the set time of the timer has elapsed (Steps S007 and S008).

On the other hand, when it is determined in Step S002 that the interruption duration is not equal to or longer than the threshold (No in Step S002), the monitoring processing unit 13 determines whether the transmission interval time set in the timer is a normal transmission interval time (Step S004), and performs the following processing of Steps S005 and S006. Similarly, the transmission control unit 12 performs the processing of Steps S007 and S008.

Note that the transmission interval time set in the timer may be applied only to the transmission timing of the pending frame to the failed ECU 200, or may be applied to the transmission timing to all the ECUs 200 connected to the gateway device 100.

According to such a gateway device 100, it is possible to suppress an increase in the processing load by adjusting the retransmission timing of the frame according to the communication status. In particular, since the ECU 200 in which the periodic transmission of the connection confirmation signal is interrupted is estimated to have a high possibility of failure, the ECU 200 cannot receive the CAN frame. Therefore, by adjusting the transmission interval of the pending frame to the ECU 200 according to the interruption duration of the connection confirmation signal, the gateway device 100 can continuously transmit the pending frame while suppressing an increase in its own processing load.

### Sixth Embodiment

In the first to fifth embodiments described above, the transmission interval time for retransmission of the pending frame is adjusted according to whether a predetermined monitored target is equal to or larger than a set threshold. However, the present invention is not limited to this. For example, when shortening the transmission interval time for retransmission, the gateway device 100 according to the present embodiment calculates the transmission interval time to be shortened in consideration of the communication status, that is, the network traffic load factor.

Specifically, in Step S005 of calculating a value for shortening the transmission interval time of the pending frame, the monitoring processing unit 13 acquires the load factor of the traffic of each network via the CAN controller 30. Then, for example, the monitoring processing unit 13 calculates a value for shortening the transmission interval time by using predetermined weight values respectively corresponding to a case where the load factor of the traffic is equal to or larger than a predetermined threshold and a case where the load factor of the traffic is less than the predetermined threshold.

Note that, in a case where the load factor of the traffic is equal to or larger than a predetermined threshold, the monitoring processing unit 13 associates a weight value with which the calculated value (value for shortening the transmission interval) becomes small. On the other hand, when the load factor of the traffic is less than the predetermined threshold, the monitoring processing unit 13 associates a weight value with which the calculated value (value for shortening the transmission interval) becomes large.

The calculation of the transmission interval time by weighting in consideration of such a traffic load factor prevents the network traffic from being instantly congested. For example, when the transmission interval time for retransmission of the pending frame is shortened, it is preferable to transmit all the pending frames to the target ECU 200 at an early interval time. However, when many pending frames are sent to the CAN bus in a short period of time without considering the traffic load factor of the network, the traffic load factor of the network increases at once. In order to prevent this, the gateway device 100 according to the present embodiment calculates a value for shortening the transmission interval time for retransmission of the pending frame in consideration of the traffic load factor.

Note that the processing in Steps S006 to S008 is similar to that described above, and thus detailed description thereof will be omitted.

According to the gateway device 100 as described above, when the transmission interval time for retransmission of the pending frame is shortened, it is possible to suppress an increase in the processing load by adjusting the retransmission timing of the frame according to the communication status and the load state while preventing the traffic of the network from being instantaneously congested.

In the first to fifth embodiments described above, when it is determined that the monitored target is less than the predetermined set threshold, the transmission interval time for retransmission of the pending frame is gradually reduced, but the present invention is not limited thereto. For example, when it is determined in Step S004 described above that the timer set time is not the normal transmission interval time of the pending frame (No in Step S004), that is, when the transmission interval time is set longer than usual, a value to be returned to the normal transmission interval time instead of stepwise may be calculated and set in the timer in Step S005. In this way, all the pending frames can be transmitted to the ECU 200 estimated to have recovered from the failure more quickly.

Further, such setting of the transmission interval time is effective when combined with the above-described sixth embodiment in which the final transmission interval time is calculated in consideration of the traffic load factor. According to such a combination, since the traffic load factor of the network is taken into consideration, all the pending frames can be transmitted to the target ECU 200 more quickly without tightening the traffic.

Further, the invention is not limited to the embodiments described above, but includes various modifications. For example, the above embodiments have been described in detail for easy understanding of the invention, and the invention is not necessarily limited to having all the configurations described. In addition, some of the configurations of a certain embodiment may be replaced with the configurations of the other embodiments, and the configurations of the other embodiments may be added to the configurations of the subject embodiment. It is possible to add, delete, and replace other configurations for a part of the configuration of each embodiment.

In addition, in the above description, only control lines and information lines considered to be necessary for explanation are illustrated, but not all the control lines and the information lines for a product are illustrated. In practice, almost all the configurations may be considered to be connected to each other.

### REFERENCE SIGNS LIST

1000 in-vehicle network system
100 gateway device
10 control unit
11 reception control unit
12 transmission control unit
13 monitoring processing unit
20 frame buffer
30 CAN controller
110 arithmetic device
120 main storage device
130 external storage device
140 communication device
150 bus
200 ECU

1. A gateway device that relays a data frame between ECUs connected to an in-vehicle network, the gateway device comprising:
a monitoring processing unit that monitors a predetermined monitored target; and
a transmission control unit that transmits the data frame to the ECU,
wherein
the monitoring processing unit is configured to:
calculate a transmission interval time of the data frame according to a communication status in the in-vehicle network or a load state of internal processing of the gateway device, and
wherein the transmission control unit is configured to:
transmit the data frame to the ECU based on the calculated transmission interval time.

2. The gateway device according to claim 1, wherein
the monitoring processing unit is configured to:
monitor a pending quantity of the data frames that have not been received by the ECU; and
calculate a transmission interval time for extending a retransmission interval of the data frame when the pending quantity is equal to or larger than a predetermined set threshold.

3. The gateway device according to claim 1, wherein
the monitoring processing unit is configured to:
monitor a load state due to retransmission processing of the data frame that has not been received by the ECU; and
calculate a transmission interval time for extending a retransmission interval of the data frame when the load is equal to or larger than a predetermined set threshold.

4. The gateway device according to claim 1, wherein
the monitoring processing unit is configured to:
monitor the number of detected communication errors in the in-vehicle network; and
calculate a transmission interval time for extending a retransmission interval of the data frame when the number of times of detection is equal to or larger than a predetermined set threshold.

5. The gateway device according to claim 1, wherein
the monitoring processing unit is configured to:
monitor a duration of a communication error in the in-vehicle network; and
calculate a transmission interval time for extending a retransmission interval of the data frame when the duration is equal to or longer than a predetermined set threshold.

6. The gateway device according to claim 1, wherein
the monitoring processing unit is configured to:
monitor a reception status of a predetermined signal periodically transmitted from the ECU; and
calculate a transmission interval time for extending a retransmission interval of the data frame when a duration after reception of the signal is interrupted is equal to or longer than a predetermined set threshold.

7. The gateway device according to, claim 2 wherein
the monitoring processing unit is configured to:
calculate a transmission interval time for shortening a retransmission interval of the data frame when the monitored target is less than the predetermined set threshold.

8. The gateway device according to claim 7, wherein
the monitoring processing unit is configured to:
acquire a load factor of traffic in the in-vehicle network;
when the monitored target is less than the predetermined set threshold and the load factor of the traffic is equal to or larger than a predetermined threshold,
calculate the transmission interval time such that a value for shortening a retransmission interval becomes small; and
when the load factor of the traffic is less than the predetermined threshold,
calculate the transmission interval time such that a value for shortening a retransmission interval becomes large.

9. The gateway device according to, claim 2 wherein
the monitoring processing unit is configured to:
continue retransmission of the data frame while adjusting the transmission interval time even when the monitored target is equal to or larger than the predetermined set threshold.

10. A data frame transmission method of a gateway device that relays a data frame between ECUs connected to an in-vehicle network,
wherein the gateway device is configured to perform:
a monitoring step of monitoring a predetermined monitored target; and
a transmitting step of transmitting the data frame to the ECU,
wherein, in the monitoring step, a transmission interval time of the data frame is calculated according to a communication status in the in-vehicle network or a load state of internal processing of the gateway device, and
wherein, in the transmitting step, the data frame is transmitted to the ECU based on the calculated transmission interval time.

11. A program for causing a computer to function as a gateway device that relays a data frame between ECUs connected to an in-vehicle network, the program causing the computer to function as:
the computer is further configured to function as:
a monitoring processing unit that monitors a predetermined monitored target; and
a transmission control unit that transmits the data frame to the ECU,
wherein the monitoring processing unit is configured to:
calculate a transmission interval time of the data frame according to a communication status in the in-vehicle network or a load state of internal processing of the gateway device, and
wherein the transmission control unit is configured to:
transmit the data frame to the ECU based on the calculated transmission interval time.
